(19) United States
(12) Patent Application Publication
(10) Pub. No.: US 2013/0284097 A1
(43) Pub. Date: Oct. 31, 2013

(54) GAS DISTRIBUTION MODULE FOR INSERTION IN LATERAL FLOW CHAMBERS

(71) Applicants: Joseph M. Ranish, San Jose, CA (US); Mehmet Tugrul Samir, Mountain View, CA (US)

(72) Inventors: Joseph M. Ranish, San Jose, CA (US); Mehmet Tugrul Samir, Mountain View, CA (US)

(21) Appl. No.: 13/785,454

(22) Filed: Mar. 5, 2013

Related U.S. Application Data
(60) Provisional application No. 61/638,005, filed on Apr. 25, 2012.
(60) Provisional application No. 61/662,154, filed on Jun. 20, 2012.

(51) Int. Cl. B05B 3/00

(52) U.S. Cl. CPC B05B 3/00
USPC 118/728

(57) ABSTRACT

Embodiments of the invention generally relate to apparatus for and methods of depositing material on a substrate. The apparatus generally include a process chamber having a process gas region therein. Process gas is introduced into the process gas region through a process gas inlet. The chamber also includes lamps positioned outside the chamber to thermally decompose the process gas onto the substrate surface. The process chamber also includes at least one movable gas diffuser adapted to provide process gas to the surface of the substrate to effect a uniform deposition of material on the substrate surface. The methods generally include flowing a process gas parallel to a surface of a substrate, and thermally decomposing the process gas on the substrate. Additional process gas is provided through a movable gas diffuser to the surface of the substrate in a predetermined distribution to effect a uniform deposition on the substrate surface.

### CROSS-REFERENCE TO RELATED APPLICATIONS

This application claims benefit of U.S. Provisional Patent Application Ser. No. 61/638,005, filed Apr. 25, 2012, and U.S. Provisional Patent Application Ser. No. 61/662,154, filed Jun. 20, 2012. The aforementioned applications are herein incorporated by reference.

### BACKGROUND OF THE INVENTION

1. Field of the Invention

Embodiments of the present invention generally relate to gas distribution in lateral flow chambers.

2. Description of the Related Art

Semiconductor substrates are processed for a wide variety of applications, including the fabrication of integrated devices and microdevices. One method of processing substrates includes depositing a material, such as a dielectric material or a conductive metal, on an upper surface of the substrate. The material may be deposited in a lateral flow chamber by flowing a process gas parallel to the surface of a substrate positioned on a support, and thermally decomposing the process gas to deposit a material from the gas onto the substrate surface. However, the material deposited on the surface of the substrate is often non-uniform in thickness and other film properties, and therefore, negatively affects the performance of the final manufactured device.

Therefore, there is a need for an apparatus for improving deposition uniformity on substrates in lateral flow chambers.

### SUMMARY OF THE INVENTION

Embodiments of the present invention generally relate to apparatus for and methods of depositing material on a substrate. The apparatus generally include a process chamber having a process gas region therein. Process gas is introduced into the process gas region through a process gas inlet. The chamber also includes lamps positioned outside the chamber to thermally decompose the process gas onto the substrate surface. The process chamber also includes at least one movable gas diffuser adapted to provide process gas to the surface of the substrate to effect a uniform deposition of material on the substrate surface. The methods generally include flowing a process gas parallel to a surface of a substrate, and thermally decomposing the process gas on the substrate. Additional process gas is provided through a movable gas diffuser to the surface of the substrate in a predetermined distribution to effect a uniform deposition on the substrate surface.

In one embodiment, a process chamber comprises a chamber body and a substrate support disposed within the chamber body. A movable gas diffuser is positioned adjacent to the surface of a substrate. The movable gas diffuser has openings formed therein for providing process gas to the surface of the substrate to effect a uniform deposition on the surface of the substrate.

In another embodiment, a process chamber comprises a chamber body and a substrate support disposed within the chamber body. The process chamber also includes a process gas inlet and process gas outlet. The process gas inlet and the process gas outlet are positioned to flow a process gas parallel to a surface of a substrate positioned on the substrate support. A plurality of gas diffusers comprising a ceramic material are positioned adjacent to the surface of the substrate. Each of the gas diffusers has openings formed therein for providing process gas to the surface of the substrate to effect a uniform deposition on the surface of the substrate.

In another embodiment, a process chamber comprises a chamber body including an optically transparent dome and a substrate support comprising silicon carbide disposed within the chamber body. The process chamber also includes a process gas inlet and process gas outlet. The process gas inlet and the process gas outlet are positioned to flow a process gas parallel to a surface of a substrate positioned on the substrate support. A first gas diffuser comprising a ceramic is positioned adjacent to the surface of the substrate and above the process gas inlet. A second gas diffuser comprising the ceramic material is positioned adjacent to the surface of the substrate and above the process gas outlet. The first and second gas diffusers have openings formed therein for providing process gas to the surface of the substrate to effect a uniform deposition on the surface of the substrate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic sectional view of a processing chamber according to one embodiment of the invention.

FIG. 2 is a sectional view of the processing chamber of FIG. 1 along section line 2-2.

FIG. 3 is a bottom schematic view of a gas diffuser according to one embodiment of the invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to apparatus for and methods of depositing material on a substrate. The apparatus generally include a process chamber having a process gas region therein. Process gas is introduced into the process gas region through a process gas inlet. The chamber also includes lamps positioned outside the chamber to thermally decompose the process gas onto the substrate surface. The process chamber also includes at least one movable gas diffuser adapted to provide process gas to the surface of the substrate to effect a uniform deposition of material on the substrate surface. The methods generally include flowing a process gas parallel to a surface of a substrate, and thermally decomposing the process gas on the substrate. Additional process gas is provided through a movable gas diffuser to the surface of the substrate in a predetermined distribution to effect a uniform deposition on the substrate surface.

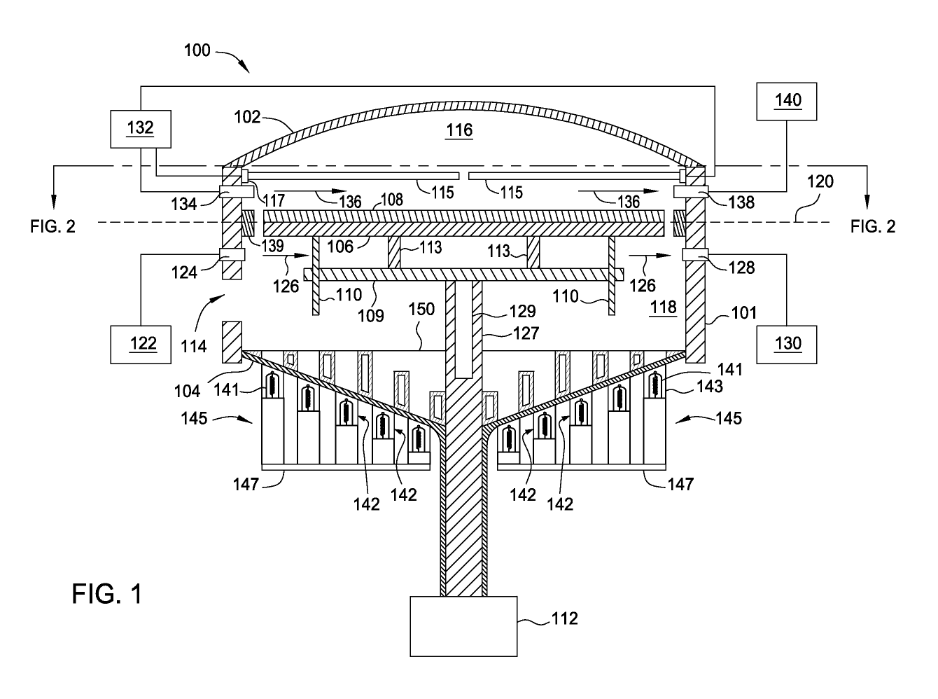

FIG. 1 is a schematic sectional view of a processing chamber 100 according to one embodiment of the invention. The processing chamber 100 may be used to process one or more substrates, including deposition of a material on an upper surface of a substrate. The processing chamber 100 includes a chamber body 101, and an upper dome 102 formed from a material such as a stainless steel, aluminum, or ceramics including quartz, alumina, yittria, or sapphire. The upper dome 102 may also be formed from coated metals or ceramics. The processing chamber 100 also includes a lower dome 104 formed from an optically transparent material such as quartz. The lower dome 104 is coupled to, or is an integral part of, the chamber body 101. A substrate support 106 adapted to support a substrate 108 thereon is disposed within the processing chamber 100 between the upper dome 102 and the lower dome 104. The substrate support 106 is coupled to a support plate 109 by pins 113. The support plate 109 is formed from an optically transparent material, such as quartz, to allow radiant energy from lamps 142 to impinge upon and heat the substrate support 106 to a desired processing temperature. The substrate support 106 is formed from silicon carbide or graphite coated in silicon carbide to absorb radiant energy from the lamps 142 and conduct the radiant energy to the substrate 108.

The substrate support 106 is shown in an elevated processing position, but may be vertically actuated by an actuator 112 to a loading position below the processing position to allow lift pins 110 to contact the lower dome 104 and raise the substrate 108 from the substrate support 106. A robot (not shown) may then enter the processing chamber 100 to engage and remove the substrate 108 therefrom through an opening 114, such as a slit valve. The substrate support 106 is also adapted to be rotated during processing by the actuator 112 to facilitate uniform processing of the substrate 108.

The substrate support 106, while located in the processing position, divides the internal volume of the chamber 100 into a process gas region 116 and a purge gas region 118. The process gas region 116 includes the internal chamber volume located between the upper dome 102 and a plane 120 of the substrate support 106 while the substrate support 106 is located in the processing position. The purge gas region 118 includes the internal chamber volume located between the lower dome 104 and the plane 120.

Purge gas supplied from a purge gas source 122 is introduced to the purge gas region 118 through a purge gas inlet 124 formed within a sidewall of the chamber body 101. The purge gas flows laterally along flow path 126 across the back surface of the support 106, and is exhausted from the purge gas region 118 through a purge gas outlet 128 located on the opposite side of the processing chamber 100 as the purge gas inlet 124. An exhaust pump 130, coupled to the purge gas outlet 128, facilitates removal of the purge gas from the purge gas region 118.

Process gas supplied from a process gas supply source 132 is introduced into the process gas region 116 through a process gas inlet 134 formed in a sidewall of the chamber body 101. The process gas flows laterally across the upper surface of the substrate 108 along a flow path 136. The process gas exits the process gas region 116 through a process gas outlet 138 located on the opposite side of the process chamber 100 as the process gas inlet 134. Removal of the process gas through the process gas outlet 138 is facilitated by a vacuum pump 140 coupled thereto.

One or more gas diffusing devices 115 are positioned above the substrate 108 adjacent to the surface of the substrate 108 onto which material is to be deposited. The gas diffusion devices 115 are coupled to pivoting mounts 117, which may include a motor or other actuator, to move the gas diffusion devices 115 parallel to the surface of the substrate 108. The pivoting mounts 117 are coupled to the chamber body 101 to facilitate support of the gas diffusing devices over the substrate 108. The gas diffusion devices 115 are formed from ceramic materials such as quartz, silicon carbide, sapphire, silicon coated with silicon carbide, graphite coated with silicon carbide, graphite coated with glassy carbon, or metals including steel, nickel, or coated metals, or any other material which is stable with respect to the process environment. The gas diffusing devices 115 are in fluid communication with the process gas supply 132, and are adapted to provide additional process gas to the surface of the substrate 108 in desired or predetermined locations. The gas diffusion devices 115 include a plurality of openings in a lower surface thereof to flow process gas therethrough. Gas flow through the openings may be independently controlled in order to facilitate the desired gas distribution with respect to the surface of the substrate 108.

During processing, process gas may be provided to the surface of the substrate 108 through the gas diffusers 115 as well as by the gas inlet 134. The gas diffusers 115 provide additional process gas to the surface of the substrate 108, which is thermally decomposed to facilitate a uniform deposition of material on the surface of the substrate 108. For example, it may experimentally determined that lateral flow of a process gas from the process gas inlet 134 results in a non-uniform deposition of material on the substrate 108. In such an example, additional process gas may be provided through the gas diffusers 115 in a predetermined distribution to correct the non-uniform deposition. The gas diffusers 115 may be moved or swept over the surface of the substrate 108, as gas is selectively provided through openings in the lower surface of the gas diffusers 115 to facilitate a uniform material deposition. In one example, the movement of the gas diffusers 115 and the flow of process gas therethrough may be adjusted to compensate for an edge-heavy or center-heavy deposition.

A plurality of lamps 142 containing bulbs 141 are disposed adjacent to and beneath the lower dome 104 to heat the substrate 108 as the process gas passes thereover to facilitate the deposition of a material onto the upper surface of the substrate 108. The lamps 142 are arranged in annular groups of increasing radius around a shaft 127 of the substrate support 106. The shaft 127 is formed form quartz and contains a hollow portion or cavity 129 therein, which reduces lateral displacement of radiant energy near the center of the substrate 108, thus facilitating uniform irradiation of the substrate 108.

The lamps 142 are contained in lampheads 145 and are adapted to the heat the substrate to a predetermined temperature to facilitate thermal decomposition of the process gas onto the surface of the substrate 108. In one example, the material deposited onto the substrate may be a group III, group IV, and/or group V material, or a material which includes a group III, group IV, and/or group V dopant. For example, the deposited material may be one or more of gallium arsenide, gallium nitride, or aluminum gallium nitride. The lamps 142 may be adapted to heat the substrate to a temperature of about 300 degrees Celsius to about 1200 degrees Celsius, such as about 300 degrees Celsius to about 950 degrees Celsius. Radiant energy from the lamps 142 is directed to the substrate support 106 by a light focusing assembly 150 to controllably heat the substrate 108, thus resulting in a more uniform deposition on the substrate 108. The uniform deposition on the substrate 108 results in a higher quality substrate and a more efficient manufactured device. The light focusing assembly 150 is positioned above and in contact with the lower dome 104, adjacent to the purge gas region 118. Thus, the light focusing assembly 150 is located within an internal volume of the process chamber 100.

One or more lamps 142 are positioned within the lamphead 145 which may be cooled during or after processing by a cooling fluid introduced into channels 149 located between the lamps 142. The lamphead 145 conductively cools the lower dome 104 due in part to the close proximity of the lamphead 145 to the lower dome 104. The lamphead 145 also cools the lamp walls and walls of the reflectors 143 as well. The lamps 142 are coupled to a power distribution board 147 which supplies power to each of the lamps 142.

Although FIG. 1 illustrates one embodiment of a processing chamber, additional embodiments are also contemplated. For example, in another embodiment, it is contemplated that the substrate support 106 may be formed from an optically transparent material, such as quartz, to allow for direct heating of the substrate 108. In another embodiment, the substrate support may be an annulus which supports the periphery of the substrate 108. In yet another embodiment, it is contemplated that an optional circular shield 139 may be disposed around the substrate support 106 and coupled to a sidewall of the chamber body 101. In another embodiment, the process gas supply source 132 may be adapted to supply multiple types of process gases, for example, a group III precursor gas and a group V precursor gas. The multiple process gases may be introduced into the chamber through the same process gas inlet 134, or through different process gas inlets 134. Additionally, it is also contemplated that the size, width, and/or number of gas inlets 124, 134, or gas outlets 128, 138 may be adjusted to further facilitate a uniform deposition of material on the substrate 108. In yet another embodiment, it is contemplated that the lampheads 145 are not in contact with the lower dome 104.

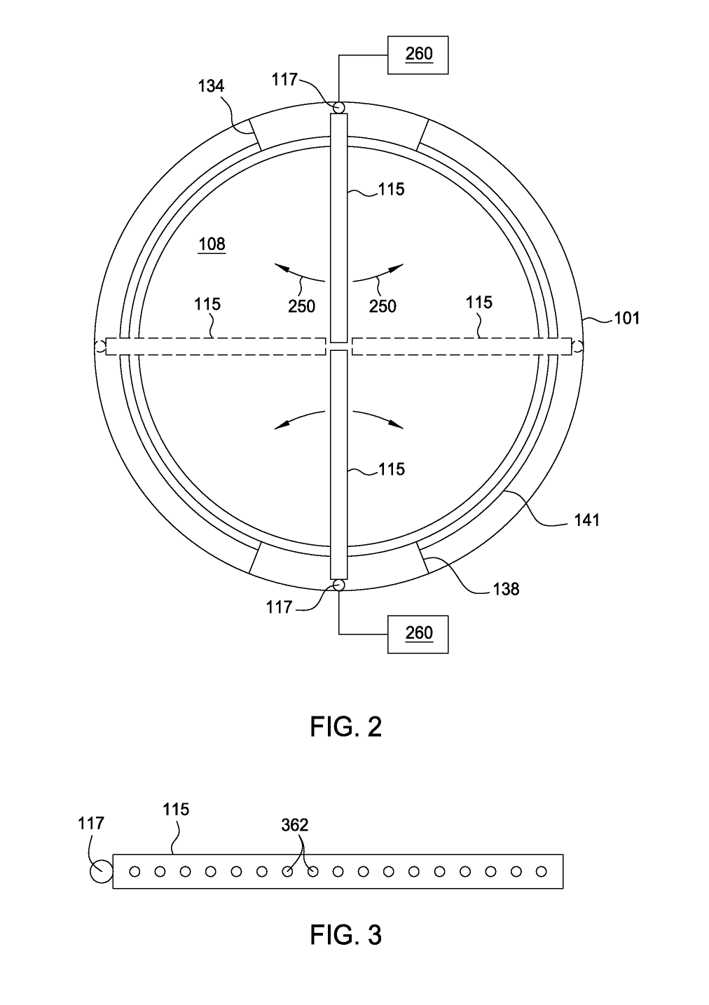

FIG. 2 is a sectional view of the processing chamber of FIG. 1 along section line 2-2. FIG. 2 illustrates a top perspective view of the substrate 108, the gas diffusers 115, the gas inlet 134, and the gas outlet 138. Two gases distribution devices 115 are shown (positioned 180 degrees apart), however, it is contemplated that additional gas diffusers (shown in phantom) may also be included. In an embodiment where four gas diffusers 115 are included, the gas diffusers 115 may be positioned about 90 degrees apart. It is contemplated that any number of gas diffusers 115 which enables sufficient distribution of process gas over the substrate 108 may be utilized, either when the substrate is stationary or rotating. Additionally, it is contemplated that multiple gas diffusers 115 may be positioned to overlap near the center of the substrate 108 to facilitate uniform deposition of the center of the substrate 108. In such an embodiment, the vertical heights of the gas diffusers may be offset to allow overlapping. Also, the gas flow through each of the overlapping gas diffusers 115 may be adjusted to ensure uniform deposition while compensating for the offset in vertical distance from the substrate 108.

The gas diffusers are tubes or other hollow objects having holes in a lower surface thereof (shown in FIG. 3), and are adapted to provide a process gas to an upper surface of the substrate 108. The gas diffusers 115 are adapted to be moved across the surface of the substrate 108 as shown by arrows 250 while pivoting at the mounts 117. The movement of the gas diffusers 115 is controlled by controllers 260, which facilitate movement of the gas diffusers 115 in a predetermined pattern. The predetermined pattern may be determined experimentally to correct for non-uniform deposition on a substrate in a lateral flow process chamber.

The gas diffusers 115 may be formed from ceramics such as quartz, silicon carbide, sapphire, silicon coated with silicon carbide, graphite coated with silicon carbide, graphite coated with glassy carbon, or metals including steel, nickel or coated metals. In one embodiment, it is contemplated that the gas diffusers 115 may be formed from quartz or another optically transparent material. In such an embodiment, absorption or reflection of radiant energy from the lamps 142 is reduced, thus increasing process uniformity. Such an embodiment may be particularly beneficial when the gas diffusers 115 are disposed between a processing surface of a substrate and lamps 142. In the embodiment shown in FIG. 1, optically transparent gas diffusers 115 reduce temperature irregularities resulting from the localized absorption or reflection of grey body radiation from a heated substrate 108.

In the embodiment shown in FIG. 2, the gas diffusers 115 are positioned over gas inlet 134 and the gas outlet 138. However, it is contemplated that the gas diffusers 115 may disposed at any angle around the chamber body 101 with respect to the gas inlet 134 and gas outlet 138, for example, about 90 degrees. In such an embodiment, process gas introduced from the gas diffusers 115 may not affect the flow of process gas entering through the process gas inlet 134, thereby further facilitating uniform deposition of material.

FIG. 3 is a bottom schematic view of a gas diffuser 115 according to one embodiment of the invention. The gas diffuser 115 includes a plurality of openings 362 therein to flow a gas therethrough. While only single row of openings 362 are shown, it is contemplated that any number of rows may be utilized, that the size, shape, and density of openings may be adjusted to provide the desired gas flow and distribution. Additionally, it is contemplated that a nozzle may be disposed in each of openings 362 to facilitate independent gas flow control through each of the openings 362.

During operation of the process chamber 100, process gas is introduced into the process gas region 116 through a process gas inlet 134 and is flown over a substrate 108, which may be rotating in order to increase deposition uniformity. The process gas is thermally decomposed to deposit a material on the substrate 108. However, the process gas may not deposit uniformly over the substrate 108. For example, material deposition near the center of the substrate may be greater than material deposition around the outside edge of the substrate. In such an example, the gas diffusers may be utilized to provide additional process gas near the perimeter of the substrate 108 to increase the material deposition near the outer edge of the substrate 108. The additional process gas from the gas diffusers 115 may be provided prior to, concurrently with, or subsequent to introduction of process gas from the process gas inlet 134.

In one embodiment, it is contemplated that process gas may be introduced through the gas diffusers 115 in a cyclical manner with process gas through the process gas inlet 134. The movement and/or position of the gas diffusers 115 may be experimentally determined by processing one or more substrates in the lateral flow chamber 100 to determined where deposition non-uniformities occur on the substrates 108. Movement of the gas diffusers 115 and the flow of process gas therethrough can then be determined to correct the non-uniformities, and can be programmed into controllers 260 to facilitate repeatable, uniform material depositions.

In another embodiment, it is contemplated that a metrology device may be utilized to detect deposition non-uniformities real-time during processing, and that the gas diffusers 115 may then be utilized to correct the deposition non-uniformities.

Benefits of the present invention include uniform material deposition in lateral flow process chambers. Movable gas diffusers positioned above a substrate and a lateral flow stream allow for corrections of deposition non-uniformity. The movement of the gas diffusers, as well as the flow of gas therethrough, is controlled by controllers which allows for process repeatability. The increased deposition uniformity on the substrates increases the quality of the substrates and the efficiency of the final manufactured devices.

While the foregoing is directed to embodiments of the present invention, other and further embodiments of the invention may be devised without departing from the basic scope thereof, and the scope thereof is determined by the claims that follow.

What is claimed is:

1. A process chamber, comprising:
a substrate support disposed within a chamber body and adapted to support a substrate; and
a movable gas diffuser positioned adjacent to a surface of the substrate, the movable gas diffuser having openings formed therein for providing process gas to the surface of the substrate to effect a uniform deposition on the surface of the substrate.

2. The process chamber of claim 1, further comprising a second movable gas diffuser positioned adjacent to the surface of the substrate.

3. The process chamber of claim 2, wherein the first and second movable gas diffusers are vertically offset from one another.

4. The process chamber of claim 2, wherein the first and second movable gas diffusers are coupled to the chamber body and are positioned about 180 degrees from one another.

5. The process chamber of claim 1, wherein the movable gas diffuser is coupled to the chamber body by a pivoting mount.

6. The process chamber of claim 1, further comprising a process gas inlet and a process gas outlet positioned to flow a process gas parallel to a surface of a substrate positioned on the substrate support, wherein the movable gas diffuser is positioned above the process gas inlet and the process gas outlet.

7. The process chamber of claim 1, wherein the movable gas diffuser comprises quartz, silicon carbide, or sapphire.

8. The process chamber of claim 1, wherein the movable gas diffuser comprises a metal coated with quartz, silicon carbide, or sapphire.

9. A process chamber, comprising:
a substrate support disposed within a chamber body;
a process gas inlet and the process gas outlet positioned to flow a process gas parallel to a surface of a substrate positioned on the substrate support; and
a plurality of gas diffusers comprising a ceramic material positioned adjacent to the surface of the substrate, each of the gas diffusers having openings formed therein for providing process gas to the surface of the substrate to effect a uniform deposition on the surface of the substrate.

10. The process chamber of claim 9, wherein at least one of gas diffusers is positioned above the process gas inlet and at least one other gas diffuser of the plurality of gas diffusers is positioned above the process gas outlet.

11. The process chamber of claim 9, wherein at least one of the plurality of gas diffusers is positioned about 90 degrees from the process gas inlet.

12. The process chamber of claim 9, wherein the gas diffusers are positioned vertically above the process gas inlet and the process gas outlet.

13. The process chamber of claim 9, wherein the plurality of gas diffusers is at least four gas diffusers.

14. The process chamber of claim 9, wherein each movable gas diffuser is coupled to the chamber body by a pivoting mount.

15. The process chamber of claim 14, further comprising a process gas supply source, wherein process gas from the process gas supply source is supplied to the gas diffusers through the pivoting mount.

16. A process chamber, comprising:
a chamber body including an optically transparent dome;
a substrate support disposed within the chamber body, the substrate support comprising silicon carbide;
a process gas inlet and the process gas outlet positioned to flow a process gas parallel to a surface of a substrate positioned on the substrate support;
a first gas diffuser comprising a ceramic material positioned adjacent to the surface of the substrate and above the process gas inlet; and
a second gas diffuser comprising the ceramic material positioned adjacent to the surface of the substrate and above the process gas outlet, the first and second gas diffusers having openings formed therein for providing process gas to the surface of the substrate to effect a uniform deposition on the surface of the substrate.

17. The process chamber of claim 16, further comprising a controller coupled to the first and second gas diffusers to control the movement of the first and second gas diffusers and the flow of process gas therethrough.

18. The process chamber of claim 16, wherein the first and second gas diffusers are positioned 180 degrees from one another.

19. The process chamber of claim 16, wherein the first and second gas diffusers are coupled to a pivoting mount.
